(19) United States
(12) Patent Application Publication
(10) Pub. No.: US 2026/0278044 A1
(43) Pub. Date: Sep. 17, 2026

(54) SYSTEM AND METHOD FOR POSTING NON-FUNGIBLE TOKEN (NFT) AND PROVING OWNERSHIP THEREOF

(71) Applicant: LG ELECTRONICS INC., Seoul (KR)

(72) Inventors: Changsu HA, Seoul (KR); Jihyoun RYU, Seoul (KR); Juneyong KWON, Seoul (KR)

(73) Assignee: LG ELECTRONICS INC., Seoul (KR)

(21) Appl. No.: 19/222,031

(22) Filed: May 29, 2025

(30) Foreign Application Priority Data
Mar. 13, 2025 (KR) 10-2025-0032696

(51) Int. Cl. G06F 21/10; G06F 21/31

(52) U.S. Cl. CPC G06F 21/1015; G06F 21/31; G06F 2221/2141

(57) ABSTRACT

The present disclosure relates to a system and a method for posting a non-fungible token (NFT) and proving ownership thereof. The system of the present disclosure includes a user's terminal, an interface, a server, and a database, and the server inquires NFT ownership information in a blockchain network and compares the same with SNS account information to generate an ownership proving page. The user verifies NFT ownership via the generated ownership proving page, and posts the same on an SNS platform. According to the present disclosure, the ownership verification of the NFT is automated and data reliability is secured.

This application claims the benefit of Korean Patent Application No. 10-2025-0032696, filed on Mar. 13, 2025, which is hereby incorporated by reference as if fully set forth herein.

### BACKGROUND

### Field

The present disclosure relates to a system and a method for posting an NFT and proving ownership thereof, and more particularly, to a system and a method for creating a post for authenticating an owned NFT on an SNS platform of Web 2.0 and proving ownership of the NFT via the post.

### Discussion of the Related Art

Blockchain is a technology designed to store data distributively and make it difficult to change the data, and is mainly used in finance, security, and authentication. A non-fungible token (NFT) based on the blockchain, as a digital asset that may prove its uniqueness and ownership, is used in various fields such as works of art, game items, and membership cards.

Web 3.0 is a next-generation web technology based on blockchain and decentralization technologies and has a difference that distinguishes it from an existing centralized Internet environment. For example, greater data ownership and security may be provided to a user.

One of key elements of the Web 3.0 is a decentralized application (DApp). The DApp is an application that runs on a blockchain network and is operated using smart contracts without a central server. Unlike an existing centralized application, the DApp may increase transparency and security by recording data on the blockchain.

As a use of crypto asset and the non-flexible token (NFT) increases, a need of the user to share his/her crypto asset via a social network service (SNS) and prove the ownership is increasing.

In an existing Web3 environment, it is common to use a specific Web3-only community channel to authenticate a user with a specific crypto asset, but there are limitations although this method is able to verify reliability of the crypto asset owner.

For example, the existing crypto asset authentication method is able to be used only in a specific community platform, making it difficult for a general user to access the same.

This method is useful for a user familiar with the Web3 environment, but the use of this method is limited because of a high entry barrier for the general user who mainly uses a Web2-based SNS.

In addition, there is a function of posting the crypto asset on the SNS, but there is a lack of a method of verifying whether the posted asset is actually owned by the corresponding user. Currently, the user is able to arbitrarily upload a crypto asset image, which may lead to creation of a fake post, so that technical supplementation is needed to increase reliability of the post.

As such, in the current Web3 environment, there is a lack of effective technology to prove the crypto asset ownership on the SNS, and the existing method is dependent on the specific platform and thus the utilization thereof is limited. Therefore, a wallet-based crypto asset ownership proof technology compatible with the SNS is required.

### SUMMARY

A purpose of the present disclosure is to provide a technology for securing reliability of a crypto asset post by enabling identity of a crypto asset owner to be easily proved on an SNS.

In addition, a purpose of the present disclosure is to provide a wallet-based crypto asset ownership proving system that may be used on various SNS without being limited to a specific community platform.

Technical tasks obtainable from the present disclosure are non-limited by the above-mentioned technical tasks. And, other unmentioned technical tasks can be clearly understood from the following description by those having ordinary skill in the technical field to which the present disclosure pertains.

Additional advantages, objects, and features of the disclosure will be set forth in the disclosure herein as well as the accompanying drawings. Such aspects may also be appreciated by those skilled in the art based on the disclosure herein.

Proposed is a method for a user to authenticate and prove ownership of a crypto asset on a platform including receiving a posting command for the platform from a wallet of a first user who owns a target crypto asset, obtaining an access right to an account of the platform used by the first user, obtaining asset information regarding the target crypto asset from a blockchain network, generating ownership authentication content based on the asset information, and requesting the account to post the ownership authentication content based on the access right.

The generating of the ownership authentication content may include generating an ownership proving webpage for proving ownership of the target crypto asset of the account, generating a first link or a second link including an address of the ownership proving webpage, and creating a post including the asset information, the first link, or the second link.

The generating of the ownership proving webpage may include generating a unique code of the ownership proving webpage, and storing the asset information, first time point owner information of the target crypto asset, or first time point account information of the account in association with the unique code.

The method may further include receiving an execution command of the first link from a terminal of a second user, extracting the unique code based on the first link, obtaining the asset information, the first time point owner information, or the first time point account information in association with the unique code, executing ownership proving based on the obtained information, and displaying the ownership proving webpage including a result value of the ownership proving on the terminal of the second user.

The executing of the ownership proving may include obtaining second time point account information of the account from the platform, determining whether the first time point account information and the second time point account information of the account match each other, obtaining second time point owner information of the target crypto asset from the blockchain network, determining whether the first time point owner information and the second time point owner information of the target crypto asset match each other, and generating the result value of the ownership proving based on whether the two account information match each other and whether the two owner information match each other.

The method may further include receiving an execution command of the second link from a terminal of a second user, receiving a signature of the second user from a wallet of the second user, executing ownership verification for the target crypto asset, and displaying the ownership proving webpage including a result value of the ownership verification on the terminal of the second user.

The second link may include a hash value for the wallet of the second user to determine whether the execution command of the second link is valid.

The executing of the ownership verification may include verifying validity of the ownership proving webpage.

The executing of the ownership verification may include extracting the unique code based on the second link, obtaining the asset information, the first time point owner information, and the first time point account information in association with the unique code, obtaining second time point account information of the account from the platform, determining whether the second time point account information and the first time point account information of the account match each other, obtaining second time point owner information of the target crypto asset from the blockchain network, determining whether the second time point owner information and the first time point owner information match each other, and generating the result value of the ownership verification based on whether the two account information match each other and whether the two wallet address match each other.

The method may further include verifying validity of the asset information, the first time point account information, the second time point account information, the first time point owner information, or the second time point owner information.

The method may further include verifying validity of network type information of the target crypto asset.

Further, proposed is a system for providing services of posting a crypto asset and proving ownership thereof including a server that performs the method, a front-end page that displays a page received from the server and receives a user input, and a database that exchanges information with the server and stores the exchanged information therein.

According to the embodiment of the present disclosure, the reliability of the post may be secured by automatically verifying whether the user owns the crypto asset posted on the SNS via the wallet.

In addition, the crypto asset ownership may be proven on the various SNS rather than the existing Web3-only community, thereby increasing the accessibility of the general users.

In addition, whether the crypto asset is owned may be checked in real time by linking the wallet with the SNS account, thereby preventing the occurrence of the fake post.

Additional scope of applicability of the present disclosure will become apparent from the detailed description below.

However, since various changes and modifications within the technical idea and scope and scope of the present disclosure may be clearly understood by those skilled in the art, the detailed descriptions, and specific embodiments such as preferred embodiments of the present disclosure should be understood as being set forth only by way of example.

### BRIEF DESCRIPTION OF THE DRAWINGS

FIG. 1 is a block diagram of an NFT posting and ownership proving system according to an embodiment of the present disclosure.

FIG. 2 is a flowchart illustrating an NFT posting method according to an embodiment of the present disclosure.

FIG. 3 is a flowchart illustrating an NFT ownership proving method according to an embodiment of the present disclosure.

FIG. 4 is a flowchart illustrating an NFT ownership proving method according to another embodiment of the present disclosure.

FIG. 5 is a diagram illustrating a screen executed in a web browser of a decentralized application (dApp) according to an embodiment of the present disclosure.

FIG. 6 is a diagram illustrating a screen displayed in a social networking service (SNS) application according to an embodiment of the present disclosure.

FIG. 7 is a diagram illustrating a screen displayed through a general web browser according to an embodiment of the present disclosure.

FIG. 8 is a diagram illustrating a screen executed in a first digital wallet application according to an embodiment of the present disclosure.

### DESCRIPTION OF SPECIFIC EMBODIMENTS

Description will now be given in detail according to exemplary embodiments disclosed herein, with reference to the accompanying drawings. The same or equivalent components may be provided with the same reference numbers, and description thereof will not be repeated. As used herein, the suffixes “module” and “part” are added or used interchangeably to facilitate preparation of this specification and are not intended to suggest distinct meanings or functions. In describing embodiments disclosed in this specification, relevant well-known technologies may not be described in detail in order not to obscure the subject matter of the embodiments disclosed in this specification. In addition, it should be noted that the accompanying drawings are only for easy understanding of the embodiments disclosed in the present specification, and should not be construed as limiting the technical idea disclosed in the present specification. As such, the present disclosure should be construed to extend to any alterations, equivalents and substitutes in addition to those which are particularly set out in the accompanying drawings.

Although the terms first, second, etc. may be used herein to describe various elements, these elements should not be limited by these terms. These terms are generally only used to distinguish one element from another.

It will be understood that when an element is referred to as being “connected with” another element, the element can be directly connected with the other element or intervening elements may also be present. In contrast, it will be understood that when an element is referred to as being “directly connected with” another element, there are no intervening elements present.

A singular representation may include a plural representation unless it represents a different meaning from the context.

The terms such as “include” or “have” used herein are intended to indicate that features, numbers, steps, operations, elements, components, or combinations thereof used in the following description exist and it should be thus understood that the possibility of existence or addition of one or more different features, numbers, steps, operations, elements, components, or combinations thereof is not excluded.

The present disclosure relates to a system for posting a crypto asset and proving an ownership thereof, and a type of the crypto asset is not limited, but hereinafter, for convenience of description, the description will be made with an NFT among the crypto assets.

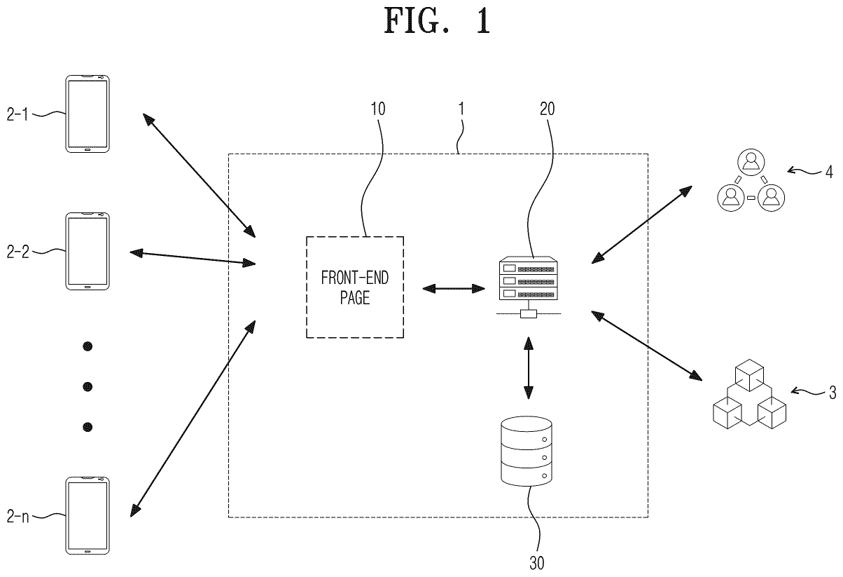

FIG. 1 is a block diagram of an NFT posting and ownership proving system according to an embodiment of the present disclosure.

An NFT posting and ownership proving system (hereinafter, referred to as a system) 1 according to an embodiment of the present disclosure may include a front-end page 10, a server 20, and a database 30.

The front-end page 10, as an element that serves to exchange data between a user and the system 1, may include a user interface (UI) and an application programming interface (API).

The user is able to make an NFT posting request or check an ownership proving result via the front-end page 10, and the corresponding request is transmitted to the server 20 and processed.

The front-end page 10 may be provided as a web-based screen (UI) on a user's terminal 2, and may include a function for the user to link an SNS account thereof or connect a wallet thereof.

In addition, the front-end page 10 may be implemented to be accessed via a mobile application or a web application, and may interact with the server 20 using a standardized communication method such as REST API or GraphQL API.

The server 20 may be physically implemented as a single or multiple server computers, and may be provided in a form of a virtualized server in a cloud environment. In general, the server may be composed of a central processing unit (CPU), a memory (RAM), a storage device (SSD/HDD), a network interface, and the like.

The server 20 may serve as a central control of the system 1, process a user's request, and provide necessary information in association with the database 30. The server 20 may receive a crypto asset posting request from the user and perform a function of generating an ownership proving webpage based thereon. In addition, the SNS account and blockchain data may be linked together to verify whether the user owns the crypto asset, and a verification result may be provided to the user.

The server 20 may include a webpage builder, a social account manager, a crypto asset manager, and a wallet manager.

The server 20 may automatically generate the ownership proving webpage via the webpage builder, and may link the user's SNS account using the social account manager. The crypto asset manager may inquire and manage crypto asset information of the user in association with the blockchain, and the wallet manager may be in communication with the user's wallet and perform authentication for proof of ownership.

The database 30, as a data storage that stores and manages information processed by the system 1, may serve to search, modify, and delete data based on a request of the server 20.

The database 30 may store NFT post information, a proof of ownership record, user account information, SNS linkage information, wallet authentication data, and the like, and may quickly process the user's request based thereon.

In one example, the database 30 may be implemented based on a relational database (RDB) or an NoSQL database, and a distributed storage technology may be applied for large-scale data processing.

In addition, an encrypted storage method may be applied to maintain data integrity and security, and crypto asset ownership information may be reliably managed via linkage with the blockchain.

The server 20 may process the user's request in association with the database 30 and provide the ownership proving result based thereon.

A blockchain network 3, as a decentralized data network that stores and verifies the NFT and the crypto asset ownership information, may be used to check whether the user owns the crypto asset in the system 1 of the present disclosure. The blockchain network 3 may include, for example, a public blockchain such as Ethereum, Solana, Hedera (Hashgraph), and the like, and may verify ownership of an NFT and a digital asset connected to a user's wallet address. In addition, the blockchain network 3 may perform a function of storing a hash value for checking integrity of the ownership proving webpage or tracking an ownership change history.

An SNS platform 4 may refer to an existing centralized social network service through which the user may post and share the NFT.

Unlike an existing Web3-based crypto asset community, the Web2-based SNS platform 4 is a service widely used by general users, and is able to support crypto asset holders to more intuitively share their own NFT.

The system 1 of the present disclosure may be in association with the Web2-based SNS platform 4, so that the user may prove the crypto asset ownership via an SNS post.

The user's terminal 2 including the crypto asset wallet is a device for the user to manage the crypto asset and post the same on the SNS, and is able to include devices such as a smartphone, a tablet, and a personal computer (PC).

The user's terminal 2 may execute a wallet application to be in communication with the blockchain network 3, and may perform the NFT ownership proving and SNS posting functions in association with the system 1 of the present disclosure. In addition, the user's terminal 2 may be connected to the SNS platform 4 to perform functions of creating the crypto asset post, sharing a link of the ownership proving webpage, and the like.

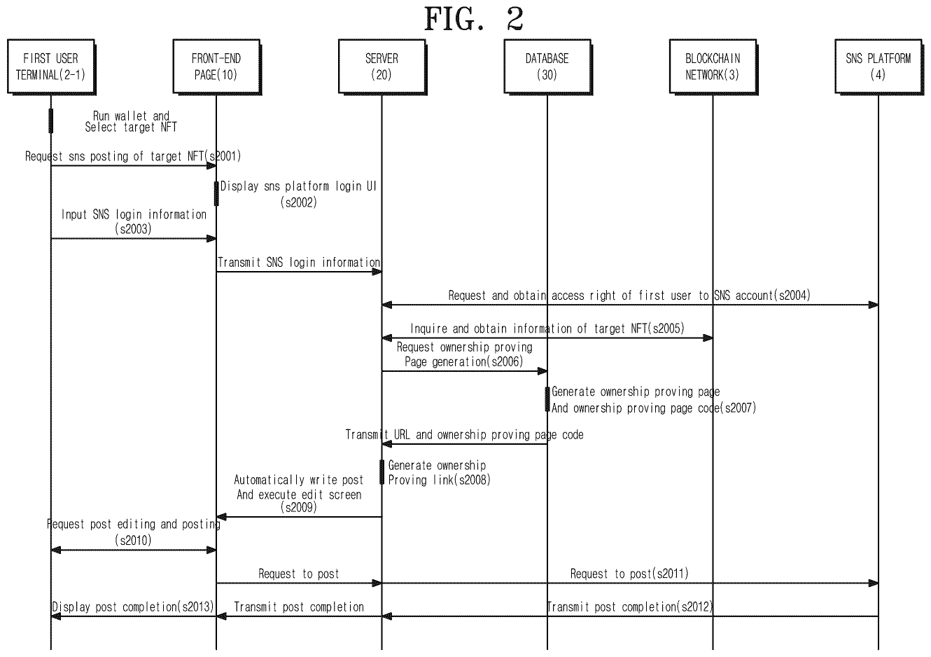

FIG. 2 is a flowchart illustrating an NFT posting method according to an embodiment of the present disclosure. For convenience of description, hereinafter, a first user may refer to a user who posts an NFT, and a second user may refer to a user who intends to verify ownership of the NFT.

First, on a terminal 2-1 of the first user, the first user may execute the wallet application, select at least one of the crypto asset and the NFT owned in the wallet, and post it on the SNS (S2001). In this regard, the NFT to be posted may be defined as a target NFT, and the user may select a type of the SNS platform on which the posting is to be made and then make an SNS posting request via various input methods (button click, command execution, and the like).

When the posting request is made, the terminal 2-1 of the first user may display a login UI of the corresponding SNS platform via the front-end page 10 of the present system 1 (S2002) and guide the user to input SNS login information. The first user may input the login information thereof, that is, account information of the corresponding SNS platform based on the guidance (S2003).

In this regard, because the first user is linked to the system via the wallet thereof using the wallet application, the system may store a wallet address (user information) of the first user, which may be viewed as an identity of the first user, and the input login information (the account information) in a linked manner.

Thereafter, the server 20 may transmit the login information received from the first user to the corresponding SNS platform 4, and obtain an access right of the first user to the SNS account (S2004).

Simultaneously, the server 20 may make a request for information of the target NFT to the blockchain network 3 and receive a response thereto (S2005). The information received from the blockchain may include metadata, ownership information, and owner information at a posting request time point (a first time point) of the target NFT.

In this regard, the owner information, as information that serves as a basis for proving that the first user owns the target NFT at the first time point, may include the fact that the target NFT is included in the wallet address (user information) of the first user at the posting request time point (the first time point).

Further, in this regard, the server may identify that a publisher posting an article to the current account is the first user and the first user owns the target NFT by linking the user information with the account information.

The server 20 may request the database 30 to generate the ownership proving webpage based on the information secured as such (S2006). The database 30 may generate the ownership proving webpage using blockchain-based NFT information, the owner information at the first time point, and the SNS account information provided from the server 20. This page may serve to prove that the first user logged into the SNS account and the NFT owner at the first time point identified on the blockchain are the same person.

After generating the ownership proving webpage, the database 30 may generate a unique identification page code (a page ID) (hereinafter, an ownership proving webpage code (the page ID)) associated with the corresponding page together (S2007). The server 20 may receive a URL of the ownership proving webpage and the ownership proving webpage code (the page ID) from the database 30, and may generate an ownership proving link (a first link) using the received URL and code (S2008). That is, the first link may include content capable of extracting the ownership proving webpage code (the page ID).

Thereafter, the server 20 may automatically create an SNS post including the generated first link, and may display a post edit screen such that the corresponding post may be edited on the terminal 2-1 of the first user (S2009). After modifying the post as desired, the first user may make a posting progress request (S2010).

When the posting request is transmitted to the server 20, the server 20 may transmit the posting request to the corresponding SNS platform 4 (S2011), and when the posting is completed on the SNS platform 4, the server 20 may receive posting completion information (S2012). The server 20 may transmit a posting completion result to the terminal 2-1 of the first user, and display a posting completion state on a screen (S2013).

With the method of the present disclosure, the first user may easily post the NFT thereof using the SNS platform and may reliably prove the ownership of the target NFT via the ownership proving webpage.

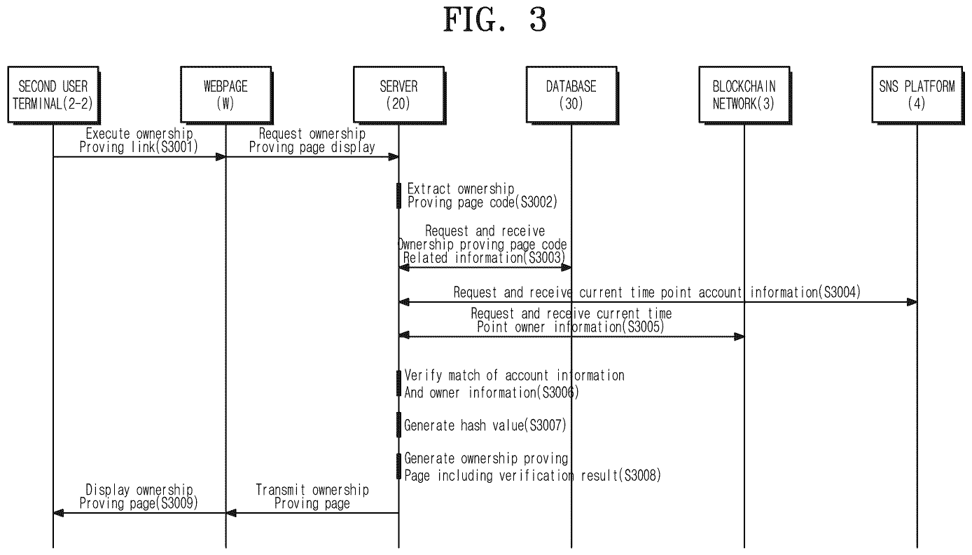

FIG. 3 is a flowchart illustrating an NFT ownership proving method according to an embodiment of the present disclosure. The proving method to be described below may be described on the premise that it is a process performed after the above-described posting method in FIG. 2 is preceded.

First, the second user may check the post including the ownership proving link (the first link) posted by the first user. In this regard, the second user may be desired to check whether the NFT included in the post is actually owned by the first user, that is, whether the post is authentic. Accordingly, the second user may execute the ownership proving link on a terminal 2-2 thereof to view the ownership proving webpage (S3001).

The server 20 may receive a request for viewing the ownership proving webpage from the terminal 2-2 of the second user, and extract the ownership proving webpage code (the page ID) using the ownership proving link (the first link) (S3002). Thereafter, the server 20 may make a request for the NFT information, the owner information at the first time point, and the SNS account information corresponding to the corresponding page code (the page ID) to the database 30 based on the extracted ownership proving webpage code (the page ID) (S3003).

The server 20 may make a request for current (second time point) SNS account information of the first user to the corresponding SNS platform 4 by utilizing the account information received from the database 30 (S3004). In more detail, because there is a possibility that the first user has changed an SNS account name or account display information between the first time point and the second time point, the server 20 may receive account information at the second time point from the SNS platform 4 and determine which account is the account of the first user regardless of whether the change has been made.

Thereafter, the server 20 may inquire the blockchain network 3 about current (the second time point) owner information of the target NFT (S3005). Because the blockchain network 3 is a reliable database with integrity, it may be ensured that an owner at the second time point recorded in the blockchain is the current owner of the target NFT. In this regard, the owner information identified from the blockchain network may be wallet information of the first user or another wallet information, and whether the account information matches the owner information may be identified to determine whether the first user's wallet still holds the posted NFT (S3006).

Thereafter, the server 20 may generate a hash value to ensure integrity of the ownership proving webpage (S3007). The hash value may be generated by combining key information of the ownership proving webpage (e.g., the metadata of the NFT, the SNS account information, the owner (wallet) information inquired from the blockchain network, and the like) into one data and then applying a cryptographic hash function (SHA-256 or the like).

The generated hash value may be used as a criterion for verifying that the ownership proving webpage has not been tampered with, and may serve to ensure reliability of the information checked by the second user.

Thereafter, the server 20 may generate the ownership proving webpage including a verification result (S3008), and the second user may verify the authenticity of the post by checking the ownership proving webpage (S3009).

For convenience of description, according to an embodiment of the present disclosure, for example, the first user may create a posting indicating that the first user owns a first NFT using an SNS account name ‘aa’, and the posting may be made including the ownership proving link (the first link) created using the present system.

Thereafter, when the first user changes the SNS account name to ‘bb’ and the second user checks the corresponding post created by the account ‘bb’, the second user may try to verify whether the account ‘bb’ still owns the first NFT. When the second user executes the ownership proving link included in the post, the ownership proving webpage may be displayed.

In more detail, the server 20 receives an ownership proving link execution request, and then searches for the original SNS account information (‘aa’) and the information of the first user corresponding to the link on the database 30. Then, the server 20 may check that the account ‘aa’ is the same person as the changed account ‘bb’ in association with the SNS platform 4, and inquire the current (the second time point) owner information of the first NFT in the blockchain network 3 to verify whether the first user still owns the target NFT.

In this process, the owner information may be identified as the wallet information of the first user, and the verification result may be provided in a state of not being modulated via the ownership proving webpage including the hash value.

As a result, when the account ‘bb’, which is the publisher, is the actual owner of the first NFT, the server 20 may display the NFT ownership verification result on the ownership proving webpage, and the second user may check the result and determine reliability of the post.

With the method of the present disclosure, the second user may effectively verify the actual owner of the posted NFT, and the first user may be provided with a function capable of continuously proving the ownership of the NFT.

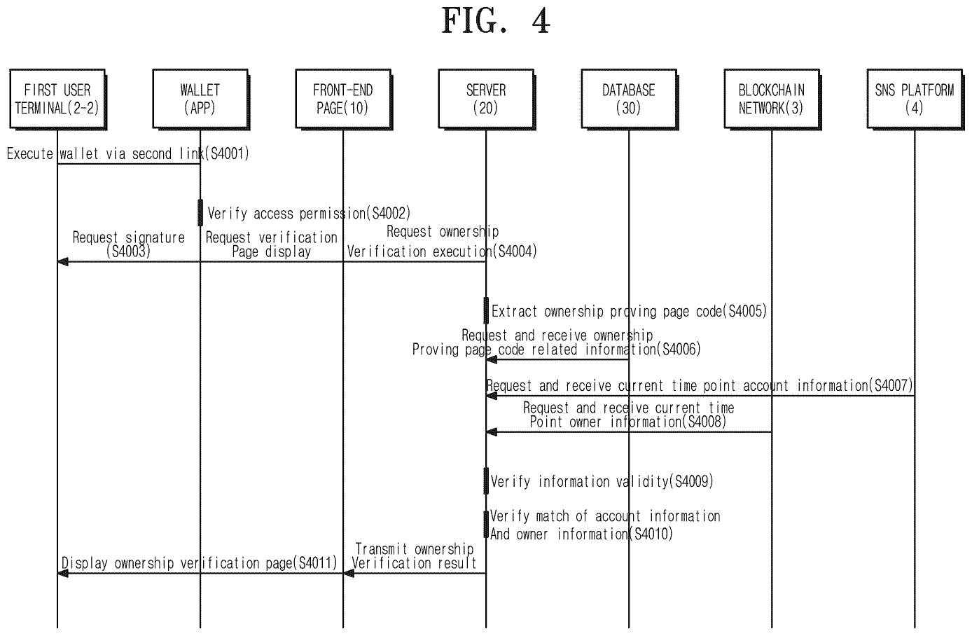

FIG. 4 is a flowchart illustrating an NFT ownership proving method according to another embodiment of the present disclosure.

Because the method described in FIG. 3 displays the ownership proving webpage via the general Web 2.0-based webpage, there may still be a possibility of forgery. For example, there may be a possibility that a malicious user forges the link and connects the link to a false ownership proving webpage, and content of the accessed page may be manipulated regardless of the actual ownership information.

Accordingly, in FIG. 4, a method for displaying an ownership proving webpage using a blockchain-based cryptocurrency wallet (hereinafter, a wallet) will be described. Because the wallet operates based on the blockchain technology, proof of ownership may be provided in a transparent and reliable manner without intervention of a central server, and manipulation unavailability may serve as a strength.

FIG. 4 is a flowchart illustrating an NFT ownership proving method according to an embodiment of the present disclosure. It is assumed that the proving method to be described below is a process of performing additional security verification after the NFT ownership proving method described above in FIG. 3 is completed.

Because the method described in FIG. 3 displays the ownership proving webpage via the general Web 2.0-based webpage, there may still be the possibility of forgery. For example, there may be the possibility that the malicious user forges the link and connects the link to the false ownership proving webpage, and the content of the accessed page may be manipulated regardless of the actual ownership information. Accordingly, in FIG. 4, a method for verifying the ownership proving webpage using the blockchain-based cryptocurrency wallet (hereinafter, the wallet) will be described.

First, the second user may execute a wallet application by executing an ownership proving link (a second link) posted by the first user (S4001). When the wallet application is executed, a process of verifying whether it is a legitimate system (DApp) with permitted access may be performed (S4002). This is a process for blocking requests generated by phishing sites or malicious websites and ensuring that only requests generated by trusted system (DApp) are processed.

Thereafter, the second user may make an ownership verification request and provide a signature in the wallet to authenticate the ownership verification request (S4003). A signature request, as a process to ensure that the verification request has not been tampered with, may serve to prove that the second user directly made the request. This may prevent an intermediate attacker from manipulating or forging the request.

The server 20 receives the request for performing the ownership verification (S4004), and then performs extraction of the ownership proving webpage code (the page ID) to obtain the code (S4005).

Thereafter, the server 20 makes a request for NFT information, owner information, and publisher information related to the corresponding page code (the page ID) to the database 30 based on the extracted ownership proving webpage code (the page ID), and receives the same (S4006).

The server makes a request for current (second time point) SNS account information to the SNS platform 4 based on the information received from the database, and receives the same (S4007). The SNS account information may be used to verify whether the account used by the publisher is the same as the current account.

At the same time, the server makes a request for the current (second time point) NFT owner information to the blockchain network 3, and receives the corresponding information (S4008). The data provided by the blockchain network is reliable information that allows a wallet address where the NFT is currently registered to be clearly identified. Because the contents of steps S4004 to S4008 are the same as those described in FIG. 3, a more detailed description thereof will be omitted.

Thereafter, the server 20 verifies validity of the NFT information, the SNS account information, and the owner information obtained from the blockchain network based on the collected data (S4009). For example, the server may check a smart contract address of the NFT and a token ID to verify whether the corresponding NFT is valid, check whether the SNS account information is the same for the account at the time of writing the post and the current account, and check whether the SNS account information matches the current owner information recorded in the blockchain network.

In addition, to maintain the integrity of the data, the hash value of the NFT metadata may be compared with an original to detect whether the data has been tampered with, and whether the wallet address connected to the SNS account information has not been changed may also be reviewed. With this process, whether the verification-requested NFT has been posted by the actual owner and whether the corresponding information has not been changed or manipulated may be determined.

Thereafter, the server may finally verify whether the SNS account information matches the NFT owner information (S4010), and may display the verification result on the ownership verification webpage (S4011). The second user may check this and finally determine whether the NFT posted by the first user actually belongs to the first user.

With the method of the present disclosure, greater reliability than that of the existing method of verifying the ownership of the NFT on the SNS may be provided, and security for determining whether the ownership proving webpage has been forged or altered may be additionally secured via the verification function using the wallet.

For example, when the first user posts the NFT thereof along with the ownership proving webpage on the SNS, and the second user desires to check the corresponding post and review the proof of ownership, the second user may perform the additional verification by executing the wallet.

When the second user executes a wallet verification function on the ownership proving webpage, the server 20 may check whether the ownership proving webpage is a legitimate page generated in the present system and authenticate it via the wallet.

In addition, the hash values may be compared with each other via the wallet to ensure that ownership proof information checked by the user has not been tampered with.

The hash value may be generated by combining the NFT information, the SNS account information, the owner (wallet) information retrieved from the blockchain network to each other and then applying the hash function (the SHA-256 or the like), and the hash value may be used as a criterion for verifying the reliability of the ownership proving webpage.

When the publisher is identified as the first user and still holds the corresponding NFT in the blockchain network as a result of the verification, the server 20 may display the corresponding result on the ownership proving webpage, and the second user may check the result and determine the reliability of the post.

Although the above description of FIG. 4 is based on the process of FIG. 3, it is not necessary to go through the webpage-based ownership verification step, and the direct verification process via the wallet application is able to be directly connected. For example, the second link directly connected to the wallet application may be included in the post. In this case, because the webpage-based proof of ownership is not performed, a portion of the description thereof may not be applied. This is obvious to a person skilled in the art, and thus, additional description thereof is omitted.

With the method of the present disclosure, the greater reliability than that of the existing method of verifying the ownership of the NFT on the SNS may be provided, and the security for determining whether the ownership proving webpage has been forged or altered may be additionally secured via the verification function using the wallet.

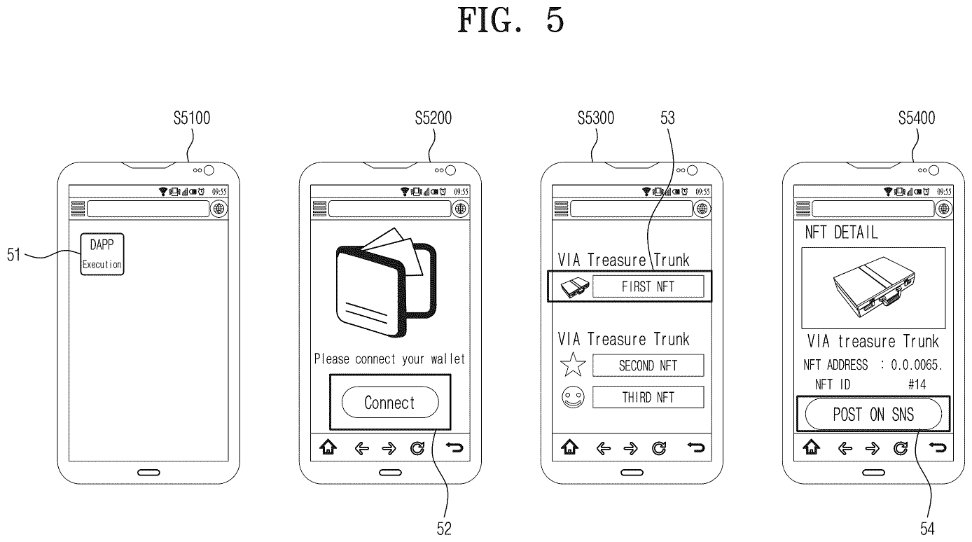

Hereinafter, a screen of a terminal according to an embodiment of the present disclosure will be described with reference to FIGS. 5 to 8 to help the description of the present disclosure.

An application environment shown in each drawing is as follows.

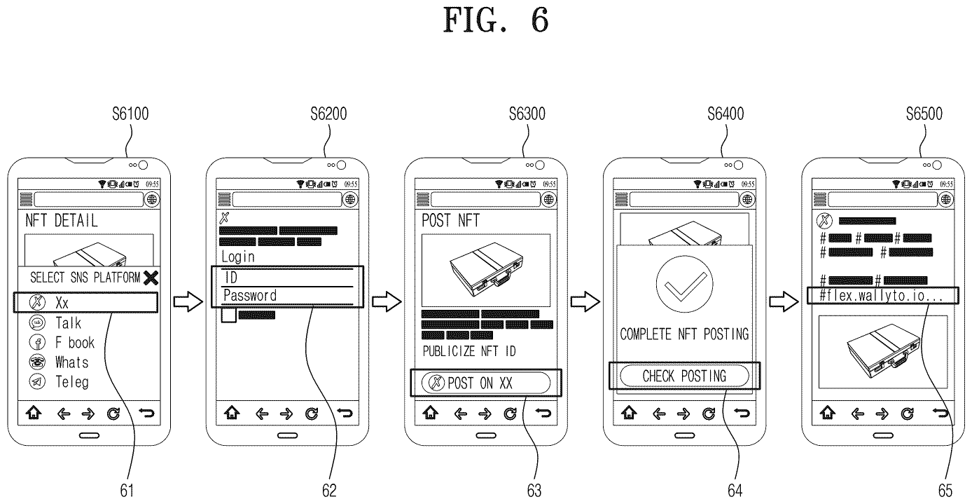

Screens of FIG. 5 (S5100 to S5400) and FIG. 6 (S6100 to S6400) are screens executed in a web browser of the DApp.

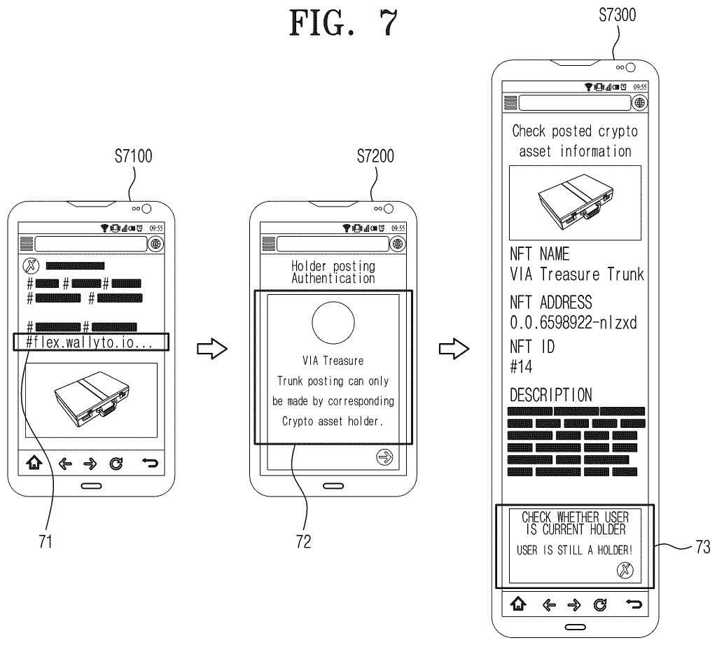

Screens of FIG. 6 (S6500) and FIG. 7 (S7100) are screens displayed in an SNS application.

Screens of FIG. 7 (S7200 to S7300) are screens displayed via a general web browser.

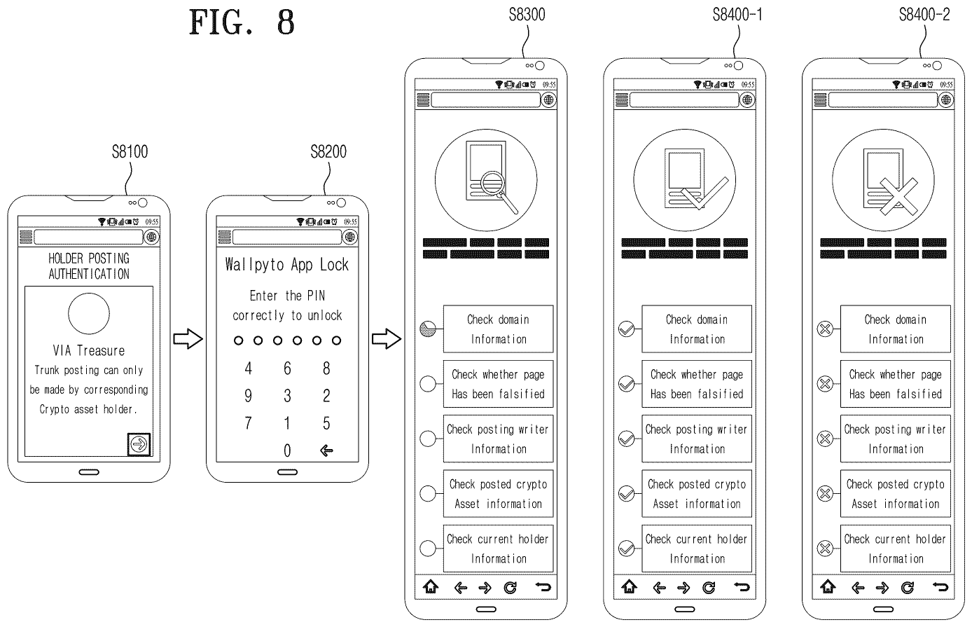

Screens of FIG. 8 (S8200 to S8400) are screens executed in a first electronic wallet application.

FIG. 5 illustrates screens including a NFT posting procedure and a user interface (UI) element according to an embodiment of the present disclosure.

The first user may execute the distributed application (Dapp) on the terminal (S5100). The first user may execute the DApp by clicking a “DApp execution” button 51 displayed on the terminal.

Thereafter, the DApp may request a connection with the blockchain wallet (S5200). That is, the first user may connect the blockchain wallet thereof to the DApp by clicking a “connect” button 52. In this regard, the corresponding button may be a UI element that performs the user's wallet linkage, and a size and a color thereof may be emphasized.

When the wallet is normally connected, a list of NFTs owned by the first user may be displayed, and the first user may select an NFT 53 to be posted from among the NFT items displayed on the screen (S5300).

The present screen may be arranged in a list format such that the user may check the NFT assets thereof at a glance, and a selectable NFT item may be visually distinguished via UI effects such as border emphasis or a specific color change.

When the NFT is selected, an NFT detailed information screen may be displayed, and information such as an NFT image, an NFT address, and an NFT ID may be included therein 54. In the present screen, main information of the NFT may be intuitively provided to the user, and the user may post the corresponding SNS on the SNS by selecting a “post on SNS” button (S5400).

Referring to FIG. 6 together, when the first user selects the “post on SNS” button (S6100), an SNS platform selection screen may be displayed. For example, as illustrated, the first user may select a desired platform from among various SNS platforms such as X (Twitter), KakaoTalk, and Facebook displayed on the screen, and a selected platform 61 may be visually emphasized.

When the SNS platform is selected, an SNS login screen may be displayed (S6200), and the first user may grant access rights to the SNS account by inputting account information thereof into a login information input field 62. The present screen may include an email or user name input box, a password input box, and a “login” or “authentication approval” button, and arrangement of the UI elements may vary depending on an interface of an SNS service provider.

When the SNS login and the authentication are completed, an NFT posting screen may be displayed (S6300), and the first user may select a posting button 63 after reviewing an automatically generated posting. The present screen may include the NFT image, a description of the NFT, a hashtag, and an NFT ownership proving link, and the user may modify the contents when desired.

When the NFT posting button is selected, a posting request may be transmitted via the SNS platform, and a posting completion screen may be displayed (S6400). The present screen may be provided with a “check posting” button 64 along with an “NFT post complete” message, and when the user selects the button, the user may check the NFT post posted on the SNS platform.

Finally, the NFT post posted by the first user may be displayed on the SNS platform (S6500), and the post may include the NFT image, the description, and an NFT ownership proving link 65.

FIG. 7 includes screens illustrating NFT ownership verification page access and verification procedures according to an embodiment of the present disclosure.

The second user may select the ownership proving link in the NFT post posted by the first user (S7100), and may access the ownership proving page accordingly. The post may include the NFT image, the descriptions, and the NFT ownership proving link, and a link 71 as the UI element of the present disclosure may be visually emphasized.

When the ownership proving link is selected, the ownership proving page may be loaded (S7200), and information for authenticating that the published NFT is owned by a specific wallet (holder) may be displayed on the corresponding page.

The present screen may include information such as a name of the NFT, a proof of ownership state, information of the post creator, and a posting date, and main information may be highlighted to increase readability.

When the additional verification is required, the second user may immediately inquire whether the first user owns the corresponding NFT on the blockchain via a specific button (S7300). The present screen may display the NFT image, the NFT address, the NFT ID, the description, and the like, and may include information reflecting a latest state of the owner. There may also be an indication 73 clearly indicating that the first user is the current holder.

FIG. 8 includes screens showing NFT ownership proof verification and post authenticity checking procedures according to an embodiment of the present disclosure.

The second user may verify the authenticity of the NFT post by selecting a “check with first electronic wallet application” button on the ownership verification page (S8100). When the corresponding button is selected, the user may move to the first electronic wallet application to proceed with the authentication procedure, and the additional security verification may be required.

Thereafter, the user may access the wallet via a PIN code input screen (S8200) to perform the verification. In the present process, the authentication may be performed in a state in which security is enhanced to protect the user's wallet, and the verification may proceed only when the user enters a correct PIN code.

When the authentication is completed, the second user may move to a page (S8300) that performs the verification of the post via the first electronic wallet application. The present screen may provide five main verification items for checking whether the post has been normally authenticated via the blockchain network and the first electronic wallet application system.

Thereafter, when it is confirmed that the NFT post was actually posted via the first electronic wallet application and went through the normal process, a confirmation verification result S8400-1, for example, “This posting was indeed written by the holder via the first electronic wallet application.” may be displayed.

The present screen may include an UI element indicating that a source of the NFT post is reliable, and the UI element may be visually distinguished so as to be clearly recognized by the user.

On the other hand, when the NFT post was not posted via the first electronic wallet application or the owner has changed, a verification failure result S8400-2 such as “This posting was not written via the first electronic wallet application.” may be displayed.

The present screen may provide detailed verification items for confirming the authenticity of the post again, and the user may recheck the reliability of the post.

Because the detailed description of the displayed screen has been made above with reference to FIGS. 1 to 4, redundant descriptions will be omitted.

The above detailed description is to be construed in all aspects as illustrative and not restrictive. The scope of the present disclosure should be determined by reasonable interpretation of the appended claims and all changes coming within the equivalency range of the present disclosure are intended to be embraced in the scope of the present disclosure.

1. A method for a user to authenticate and prove ownership of a crypto asset on a platform, the method comprising:
receiving a posting command for the platform from a wallet of a first user who owns a target crypto asset;
obtaining an access right to an account of the platform used by the first user;
obtaining asset information regarding the target crypto asset from a blockchain network;
generating ownership authentication content based on the asset information; and
requesting the account to post the ownership authentication content based on the access right.

2. The method of claim 1, wherein the generating of the ownership authentication content includes:
generating an ownership proving webpage for proving ownership of the target crypto asset of the account;
generating a first link or a second link including an address of the ownership proving webpage; and
creating a post including the asset information, the first link, or the second link.

3. The method of claim 2, wherein the generating of the ownership proving webpage includes:
generating a unique code of the ownership proving webpage; and
storing the asset information, first time point owner information of the target crypto asset, or first time point account information of the account in association with the unique code.

4. The method of claim 3, further comprising:
receiving an execution command of the first link from a terminal of a second user;
extracting the unique code based on the first link;
obtaining the asset information, the first time point owner information, or the first time point account information in association with the unique code;
executing ownership proving based on the obtained information; and
displaying the ownership proving webpage including a result value of the ownership proving on the terminal of the second user.

5. The method of claim 4, wherein the executing of the ownership proving includes:
obtaining second time point account information of the account from the platform;
determining whether the first time point account information and the second time point account information of the account match each other;
obtaining second time point owner information of the target crypto asset from the blockchain network;
determining whether the first time point owner information and the second time point owner information of the target crypto asset match each other; and
generating the result value of the ownership proving based on whether the two account information match each other and whether the two owner information match each other.

6. The method of claim 3, further comprising:
receiving an execution command of the second link from a terminal of a second user;
receiving a signature of the second user from a wallet of the second user;
executing ownership verification for the target crypto asset; and
displaying the ownership proving webpage including a result value of the ownership verification on the terminal of the second user.

7. The method of claim 6, wherein the second link includes a hash value for the wallet of the second user to determine whether the execution command of the second link is valid.

8. The method of claim 6, wherein the executing of the ownership verification includes verifying validity of the ownership proving webpage.

9. The method of claim 6, wherein the executing of the ownership verification includes:
extracting the unique code based on the second link;
obtaining the asset information, the first time point owner information, and the first time point account information in association with the unique code;
obtaining second time point account information of the account from the platform;
determining whether the second time point account information and the first time point account information of the account match each other;
obtaining second time point owner information of the target crypto asset from the blockchain network;
determining whether the second time point owner information and the first time point owner information match each other; and
generating the result value of the ownership verification based on whether the two account information match each other and whether the two wallet address match each other.

10. The method of claim 9, further comprising verifying validity of the asset information, the first time point account information, the second time point account information, the first time point owner information, or the second time point owner information.

11. The method of claim 9, further comprising verifying validity of network type information of the target crypto asset.

12. A system for providing services of posting a crypto asset and proving ownership thereof, the system comprising:
a server configured to perform the method of claim 1;
a front-end page configured to display a page received from the server and receive a user input; and
a database configured to exchange information with the server and store the exchanged information therein.

13. A computer-readable non-transitory recording medium having a program for causing a computer to execute the method of claim 1 recorded thereon.
